(19) United States
(12) Patent Application Publication
(10) Pub. No.: US 2009/0157478 A1
(43) Pub. Date: Jun. 18, 2009

(54) USABILITY EVALUATION METHOD AND SYSTEM OF VIRTUAL MOBILE INFORMATION APPLIANCE

(75) Inventors: Ung-Yeon YANG, Daejeon (KR); Dong-Sik JO, Daejeon (KR); Wookho SON, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/117,639

(22) Filed: May 8, 2008

(30) Foreign Application Priority Data
Dec. 17, 2007 (KR) 10-2007-0131904

(51) Int. Cl. G06Q 10/00; G06K 15/02

(52) U.S. Cl. 705/10; 705/7; 358/1.9

(57) ABSTRACT

A system for evaluating usability of a virtual mobile information appliance unites a virtual reality technology integrating various digital data created in planning and in designing a product to operate a virtual product and visualizing the virtual product in photo-realistic level, an affective technology organizing a customer's emotional evaluation on a product's design in view of engineering, an ergonomic technology quantatively measuring and analyzing body force activity involved in the operation of a product in a biomechanic manner, and a mixed reality technology supporting both tangible interface capable of directly touching the digital data and a photo-realistic visualization, to thereby finding problems of usability early, obtaining improvements such as a design of the product, improving efficiently an overall quality of the product and managing product-lifetime-cycle in a company manufacturing the product.

### FIELD OF THE INVENTION

The present invention relates to a united system and method of a virtual reality technology integrating various digital data created in planning and in designing a product to operate a virtual product and visualizing the virtual product in photo-realistic level, an affective technology organizing a customer's emotional evaluation on a product's design in view of engineering, an ergonomic technology quantatively measuring and analyzing body force activity involved in the operation of a product in a biomechanic manner, and a mixed reality technology supporting both tangible interface capable of directly touching the digital data and a photo-realistic visualization.

This work was supported by the IT R&D program of MIC/IITA [2005-S-604-03, Realistic Virtual Engineering Technology Development].

### BACKGROUND OF THE INVENTION

As well known in the art, a virtual product operation technology is widely used in CAD and applied computer graphics as a technology displaying an operation process of a virtual product in accordance with a change in time by adding kinematics information and animation information to product data (e.g., CAD data) using a 3D modeling tool on the product's appearance.

Further, HLSL (High Level Shader Language) based technology rendering 3D model data into a photo-realistic image such as 3D model data has been used widely in computer graphics through the 1990s and, for example, in 2000, as Cg technology of Nvidia.

However, algorithm handling a complicated pathway tracking of light, reflection considering property of an object and the like requires high performance computing power and resources in order to obtain a product of a photo-realistic level with high quality. Therefore, in virtual reality researching where real-time processing is very important, the abovementioned technologies are integrated and researches that enable demonstration of a realistic virtual product are in progress.

Meanwhile, in affective technology, a technology that deducts the emotional receptive results (e.g., linguistic representation) that the customer feels from a product into a relationship between an input value (e.g., physical data and personal feeling of a design element of a product) and an output value (e.g., emotional satisfaction expression score of a product's design) using an organized method is being developed.

That is to say, the design of a specific product is disassembled into detailed elements in an aspect of HCI based affective technology, and emotional evaluation data collection test is performed on a product group combined of such elements with respect to an experimentee group of people. More, an algorithm (an estimation formula of an estimation score) capable of estimating an emotional evaluation index of a specific customer group on an arbitrary product in accordance with a constant rule (e.g., evaluation criterion) is developed by establishing an equation that determines a weight of a constant input parameter through statistically analyzing the interrelationship between an emotional satisfaction of a user and a design element.

However, the conventional art described above undergoes a test procedure and an analysis and estimation formula modeling procedure by an experimentee group on a subject product already launched, which takes a lot of time. Therefore, a design preference trend of customers changes very often and thus it is difficult to analyze in a shortened time the current market status against products of various designs being launched.

Thus, in ergonomics, researches are conducted to improve with priority given to a human convenience usability problems induced during designing a feature focused product appearance and a user interface in the past. More, even in the case of information appliances, user interfaces and product appearances are being improved by applying ergonomic analyzing technologies. Especially, in the 21^{st} century, hands (or fingers) operations are increased due to the popularization of minimized personal information appliances and researches for analyzing side effects (e.g., VDT syndrome) aroused from culture background and solving such problems is in progress.

However, ergonomic analysis technology developed up to date (e.g., JACK system suggested by Pennsylvania University, U.S.A.) is a technology developed on the subject operation (e.g., factory production line operation) focusing on the action of the whole body. Accordingly, the ergonomic analysis technology has a limit in simulating the situation induced from a minute hand action and finger and analyzing such problems. Moreover, there is a need to develop an exclusive experiment device for a hand interface considering convenience of the experimentee group for organized ergonomic experiments.

In addition, a mixed reality technology is an improved technology in which a virtual reality technology having superior interaction features is supplemented with an augmented reality technology developed focusing on image conformity and synthesizing. Most examples of applying existing mixed reality technology are supporting interaction with a user by mixing a virtual entity to a low resolution video image.

For example, an issue haptic feedback (a virtual reality technology simulating physical impact and contact phenomenon) presents in research example of HITLab in New Zealand and in interaction with a virtual entity is considered important and various haptic interface technologies are developed in the art. However, since it is not good enough to satisfy the requirements of 100% completely simulating the feeling of a hand handling (especially, precisely on such a small product as a cellular phone which is the subject of the present invention) a real object, there are researches in progress trying to overcome the defects of the technology by way of applying a multimodal interaction technique using another stimulus (e.g., sound effect).

Therefore, the mixed reality technology at present is still in an insufficient state for an image expression and operation in a photo-realistic level of a virtual product required in a virtual usability evaluation scenario and for interaction operation feature support identical to an actual product experience state in a mixed reality environment.

Therefore, the technical problems are contrived by the technical limits and necessity of development as described above, and the solutions of the major four technical problems are presented, as follows:

First technical problem is to easily modify a design in a software tool environment and visualization in a photo-realistic level, to simulate in real-time a physical action of a product real-time and a operation of a S/W embedded in the product by integrating various digital data produced from the individual operation processes of product visualization and action simulation.

Second technical problem is to present an embodied technology supporting an estimation feature of customer's preference in accordance with a modification of a product's design and to solve the problem “fast update of an emotional user evaluation estimation model” in an affective technical evaluation support technology.

Third technical problem is to present a technique of designing and employing a technology of a glove-type interface device for supporting a quantitative analysis in a usability evaluation scenario of a product used by hands and to analyze a user interface evaluation and improvements of a product by utilizing such technology.

Forth technical problem is to provide a technique of designing and operating a usability evaluation platform based on mixed reality for supporting a feature of various aspects (e.g., vision, audition, tactility, cognitive results in accordance with product operation, etc.) sensible by a user from an end-product launched in the market since a technology that enables ideal virtual usability evaluation test is one embodying a mixed reality technology.

In order to solve the technical problems above, it is an object of the present invention is to provide a usability evaluation system and method of a virtual mobile information appliance which unites a virtual reality technology integrating various digital data created in planning and in designing a product to operate a virtual product and visualizing the virtual product in photo-realistic level, an affective technology organizing a customer's emotional evaluation on a product's design in view of engineering, an ergonomic technology quantatively measuring and analyzing body force activity involved in the operation of a product in a biomechanic manner, and a mixed reality technology supporting both tangible interface capable of directly touching the digital data and a photo-realistic visualization.

### SUMMARY OF THE INVENTION

In accordance with an aspect of the present invention, there is provided a system for evaluating usability of a virtual mobile information appliance, including:

a design evaluation unit for supporting emotional evaluation of a designed product in accordance with a component DB and a partially standardized guide in view of a customer and for real-time collecting design preference data based on a network online system;

a virtual product design modification and action simulation unit for uniting digital data related with the designed product to realize a photo-realistic visualization and a virtual operation;

an ergonomic based hand load evaluation unit for measuring an ergonomic based hand load and a fatigue using a hand interface based usability evaluation tool; and

a mixed reality usability evaluation unit for applying an augmented reality technology and a printing technology to the realized photo-realistic visualization and the virtual operation and for creating a usability evaluation situation based on the measured ergonomic based hand load and fatigue to provide the created usability evaluation situation to a user.

In accordance with another aspect of the present invention, there is provided A method for evaluating usability of a virtual mobile information appliance, including:

supporting an emotional evaluation in view of a customer on a product designed in accordance with a component DB and a partially standardized guide and real-time collecting design preference data based on a network online system;

realizing a photo-realistic visualization and a virtual operation by uniting digital data related with the designed product;

measuring an ergonomic based hand load and fatigue using a hand interface based usability evaluation tool; and

applying an augmented reality technology and a printing technology to the realized photo-realistic visualization and virtual operation, and creating a usability evaluation situation based on the measured ergonomic based hand load and fatigue to provide the created usability evaluation situation to a user.

### BRIEF DESCRIPTION OF THE DRAWINGS

The above and other objects and features of the present invention will become apparent from the following description of embodiments, given in conjunction with the accompanying drawings, in which:

FIG. 1 is a block diagram of a system for evaluating usability of a virtual mobile information appliance in accordance with the present invention;

FIG. 2 is a detailed block diagram of a design evaluation group depicted in FIG. 1;

FIG. 3 is a detailed block diagram of a virtual product design modification and action simulation group depicted in FIG. 1;

FIG. 4 is a detailed block diagram of an ergonomic based hand load evaluation group depicted in FIG. 1;

FIG. 5 is a detailed block diagram of a mixed reality based usability evaluation platform group depicted in FIG. 1;

FIG. 6 is a detailed diagram of an online product design evaluation tool depicted in FIG. 1;

FIG. 7 is a detailed diagram of an online product design creation/modification tool depicted in FIG. 1;

FIG. 8 is a detailed diagram of a hand interface based usability evaluation tool depicted in FIG. 1;

FIG. 9 is a detailed diagram of a virtual prototyping based usability evaluation tool depicted in FIG. 1;

FIG. 10 is a diagram depicting a design evaluation group having an online product design creation/modification tool and an online product design evaluation tool in accordance with the present invention;

FIG. 11 is a diagram depicting a virtual product design modification and action simulation group in accordance with the present invention;

FIGS. 12 and 13 are diagrams depicting an ergonomic based hand load evaluation group in accordance with the present invention;

FIG. 14 is a diagram depicting a display device of a mixed reality usability evaluation platform group in accordance with the present invention; and

FIG. 15 is a diagram schematically describing the present invention.

### DETAILED DESCRIPTION OF THE EMBODIMENTS

Hereinafter, embodiments of the present invention will be described in detail with reference to the accompanying drawings.

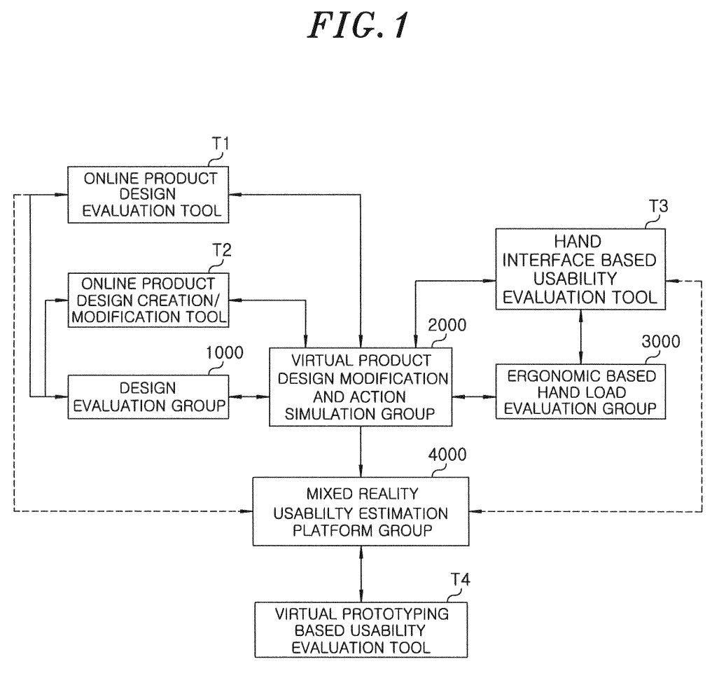

FIG. 1 is a block diagram of a usability evaluation system of a virtual mobile information appliance in accordance with an embodiment of the present invention.

The present system includes a design evaluation group 1000, a virtual product design modification and action simulation group 2000, an ergonomic based hand load evaluation group 3000 and a mixed reality usability evaluation platform group 4000. In this embodiment, the present invention further includes an online product evaluation tool T1, an online product design creation/modification tool T2, a hand interface based usability evaluation tool T3 and a virtual prototyping based usability evaluation tool T4, which are an embodiment independently executable by integrating some or all major features respectively.

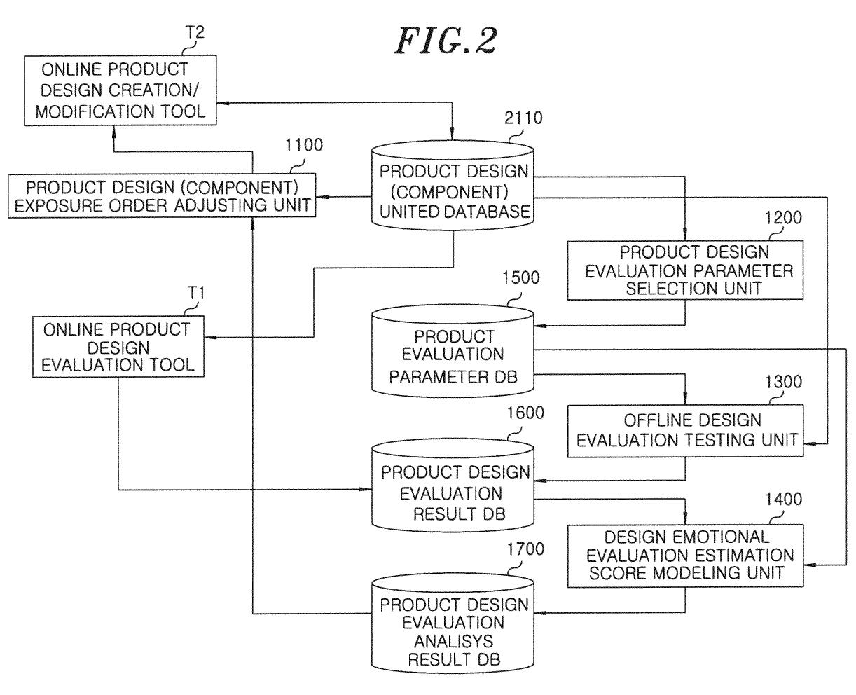

The design evaluation group 1000 provides an evaluation service in an emotional aspect of a user on a product's design and provides a feedback thereof in the system. As depicted in FIG. 2, the design evaluation group 1000 may be implemented with the online product design creation/modification tool T2 and the online product design evaluation tool T2, and the design evaluation group 1000 may also be based on a series of processes performed offline to a design emotional evaluation estimation score modeling unit 1400. A product design (component) united DB (Data Base) 2110 stores basic data such as digitalized design data of planning, designing, etc. of a product which are managed integrally.

In addition, the design evaluation group 1000 is executed by a design evaluation methodology based on affective technology being applied in industrial engineering. That is to say, in the design evaluation group 1000, emotional results that the customer feels on a product's design are classified in a form of linguistic expression (e.g., high class, satisfaction, etc.) and the interrelationship between them and product design parameters are deducted. Thus, what influence to a degree of an emotional design satisfaction of all products is estimated by the change of detailed design parameters, and, the estimation is provided to the virtual product design modification and action simulation group 2000.

Further, the design evaluation group 1000 supports emotional evaluation in a customer's aspect of a product designed in accordance with a component DB and a partially standardized guide while passing through the processes performed in a product design evaluation element selection unit 1200 to a product design evaluation analysis result DB 1700, and collects in real-time design preference data based on a network online system. The collected design preference data are then stored in the product design evaluation analysis result DB 1700. In general, the processes performed from the product design evaluation element selection unit 1200 to the product design evaluation analysis result DB 1700 are made generally in design emotional evaluation test and analysis; and, therefore, detailed description thereof will be omitted.

After going through the above processes, a recursive equation capable of estimating a degree of emotional satisfaction of a customer about a kind of the product design defined by constant design parameter is obtained. The recursive equation is used as a model equation for a design emotional score estimation equation. This may be stored in the product design (component) united DB 2110 or may yield an immediate emotional satisfaction score of a product design newly added or modified by the online product design creation/modification tool T2.

The emotional satisfaction score may control a priority of exposure of various components stored in the current product design (component) united DB 2110 and provide immediately a evaluation feedback score to a user on the basis of currently designed product's parameter. Therefore, the emotional satisfaction score can be used in supporting to achieve a design result that is satisfactory in the customer market by a user.

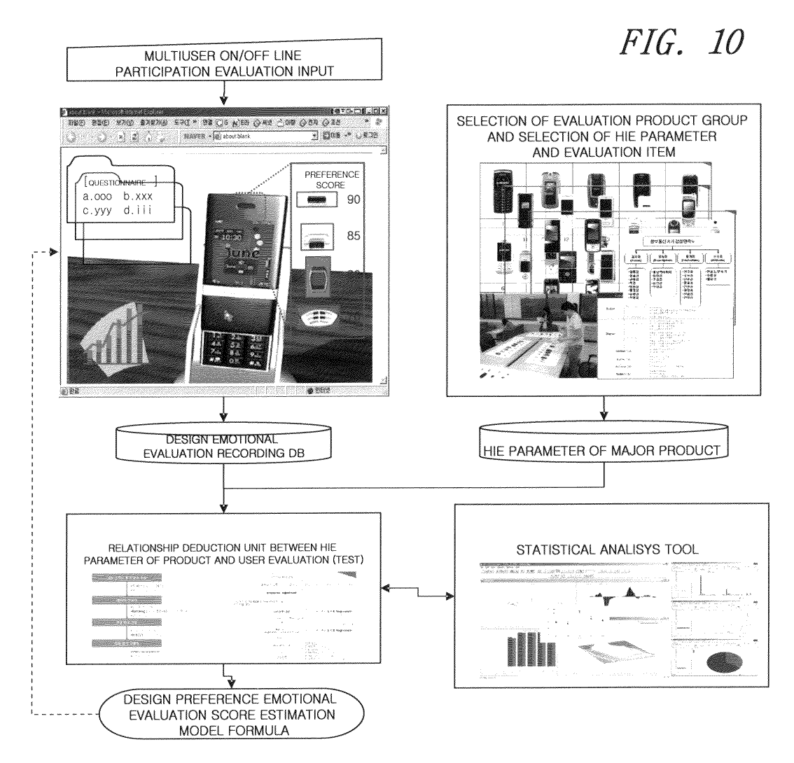

The online product design evaluation tool T1 is a tool that enables an experimental process that has been performed offline to restricted experimentees to be made by multiple experimentees that access an online system such as a web service, allows them to evaluate the product design, and then enters the evaluation score thereof. That is to say, the process of the design emotional evaluation estimation modeling unit 1400 is performed offline to a group of the restricted experimentees and is performed based on the experiment result of the product designs launched in a market at present; and, therefore, the online product design evaluation tool T1 presents a feature that supplements the restrictions on the estimation function of the design in the future in the conventional offline experiment based model creation methodology. FIG. 10 is a diagram depicting an embodiment of the design evaluation group 1000 implemented with the online product design creation/modification tool T2 and the online product design evaluation tool T1 in accordance with the present invention.

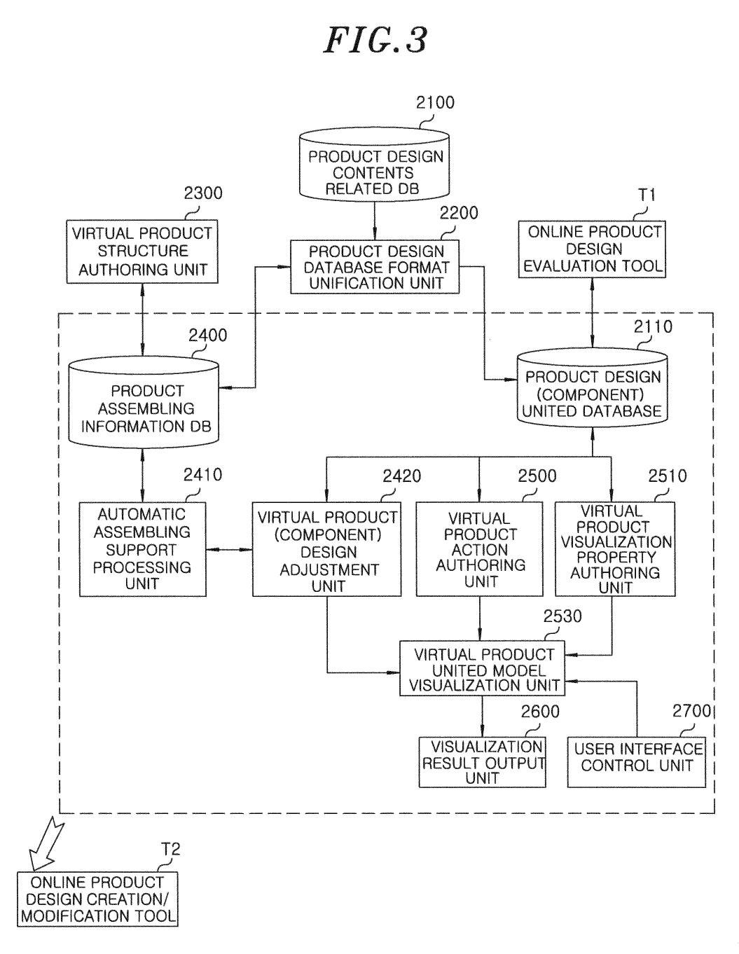

The virtual product design modification and action simulation group 2000 performs to present an expanded platform. The virtual product design modification and action simulation group 2000, as depicted in FIG. 3, integrates digital data for the design and action simulation of the product into a virtual model of an operator based on customer's emotional design satisfaction estimation result of a whole product being affected by a change of a detailed design parameter estimated by the design evaluation group 1000, so that the virtual model is easily simulated on a computer. Further, the virtual product design modification and action simulation group 2000 links with the online product design evaluation tool T1 to collect and update user information based on the web service for data updating of a design emotional evaluation estimate engine, so that a photo-realistic visualization and a virtual operation is realized by integrating the digital data related with the product designed as described above. FIG. 3 shows a detailed configuration of the virtual product design modification and action simulation group 2000.

Then, the digital data of the virtual product used in virtual product design modification and action simulation group 2000 is stored in the product design (component) united DB 2110. Digital data produced through the use of general CAD programs (e.g., CATIA, AutoCAD, 3DS Max, etc.), 2D design programs (e.g., Adobe Flash, etc.) and photo-realistic programs (e.g., Nvidia's Cg code) are stored in the product design contents related DB 2100. The digital data produced by such various programs are converted and integrated into a series of data format (e.g., COLLADA format, etc.) by a product design data format unification unit 2200 and are stored in the product design (component) united DB 2110.

A virtual product structure organizing unit 2300 constructs the design data of the virtual product in a format having a pre-defined detailed (subordinate) structure. The virtual product organizing editing unit 2300 utilizes a technique used in 3D computer graphics and virtual reality simulation, to thereby express hierarchically component structure of the virtual product, e.g., in Tree or Graph form, and defines structural movement information of each component and movement forms, e.g., animation, responding to an external input event. Such structural information of the virtual product is stored in a product assembling information DB 2400. An automatic assembling support processing unit 2410 processes to continuously sustain the interrelationship between components, e.g., by performing modification of 3D geometry information using restriction of position movement, automatic size adjustment and CAD operation, when a design parameter is modified by the online product design creation/modification tool T2 pursuant to spatial interrelationship (e.g., constraint information including parent-child subordinate relationship, group relationship, etc.) of predefined components.

A virtual product (component) design adjustment unit 2420 adjusts a physical design parameter between the components automatically assembled under creating and modifying the design and modifies the design parameter automatically or manually to obtain a natural assembled product. For example, in case of applying automatic modification, the virtual product (component) design adjustment unit 2420 automatically converts property information of a newly added component, e.g., a button, for unification with surrounding tones and material information thereof or transforms the relationship between geometry and ambient geometry of the newly added component on the basis of a constant rule or constraint condition.

A virtual product action editing unit 2500 functions to insert mechanism information into each component stored in the product design (component) united DB 2110. A virtual product visualization property editing unit 2510 functions to correct material and property information of the virtual product stored in the product design (component) united DB 2110. The functions performed in the virtual product action editing unit 2500 and virtual product visualization property editing unit 2510 can be widely employed in a general 2D or 3D design program.

A user interface control unit 2700 enables a virtual product united model visualization unit 2530 to visualize the program to be interfaced, the components in which material and property information of the corrected product and mechanism information thereof are inserted and the corrected design parameter as a virtual product action in a united form by applying a real-time screen capturing method to a plurality of product design programs executed in parallel with the online product design creation/modification tool T2. That is to say, most of the product design programs only produce shape data of a physical user interface (PUI), i.e., an external appearance of the virtual product, and support only photo-realistic visualizing in a photo-realistic level. Further, embedded software executed in the virtual product attaches only an image captured on a screen to the virtual product in a form of texture map or simulates a movement of the product by a video file. However, embedded software executed in the information appliance uses a GUI simulation program (e.g., interactive menu execution in Adobe Flash) to produce or test the virtual product.

Therefore, a virtual result output unit 2600 simulates an action of the virtual product having a completely united form of portions of the PUI and the GUI by updating in real-time the texture map by capturing 2D GUI information image on a 3D virtual object expressing PUI like an real product by a user interface 2700. Further, a user's input through a keyboard or a mouse is transmitted to a PUI visualization program and a GUI visualization program executed in parallel by applying an interface hooking technology.

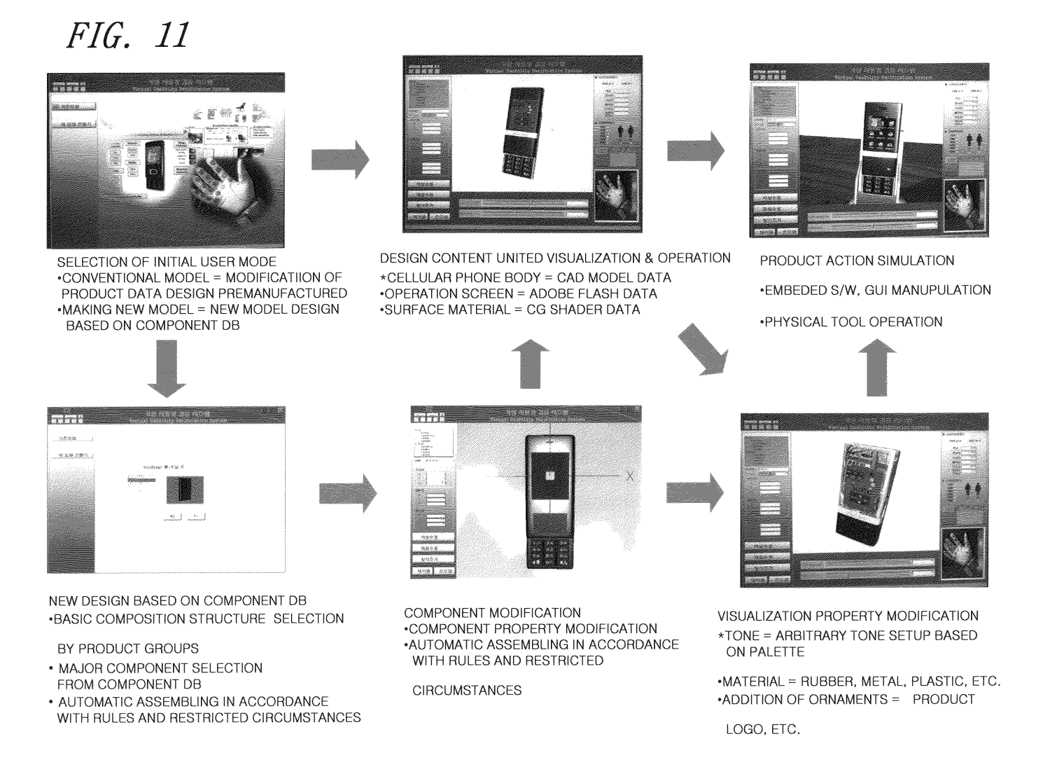

Referring to FIG. 1 again, the virtual product design modification and action simulation group 2000, when a component of the virtual product is modified, corrects and conforms automatically the size, position and shape information and property information of the virtual product, in consideration with spatial interrelationship. FIG. 11 is an exemplary embodiment of the virtual product design modification and action simulation group 2000 in accordance with the present invention.

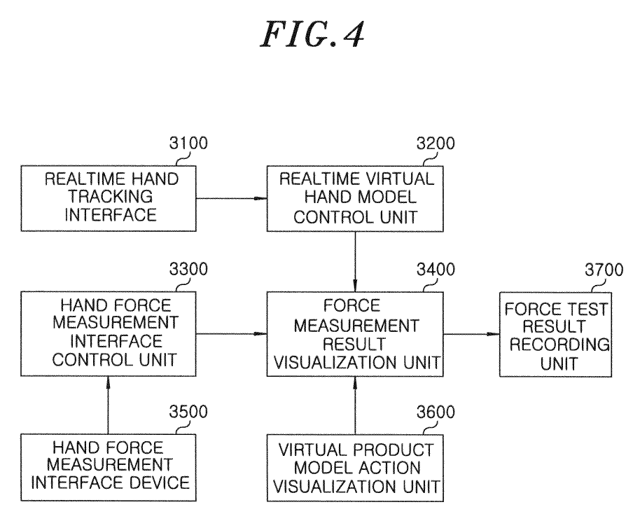

The ergonomic based hand load evaluation group 3000 measures an ergonomic based hand load and fatigue through a simulation tool to provide the same to the virtual product design modification and action simulation group 2000. The ergonomic based hand load evaluation group 3000, as depicted in FIG. 4, includes a real-time hand tracking interface 3100, a real-time virtual hand model control unit 3200, a hand force measurement interface control unit 3300, a force measurement result visualization unit 3400, a hand force measurement interface device 3500, a virtual product model action visualization unit 3600 and a force test result recording unit 3700.

The real-time hand tracking interface 3100 includes sensors that track a shape of a hand in real-time and obtains in real-time angles of all joints in the hand so that a virtual hand model is restored and visualized in real-time. For example, an angel between fingers and posture information of the hand may be trackable using Cyberglove having 22 sensors available from Immersion Corporation. Then, the attained angle information of the joints go through a series of data conversion and calibration filter for controlling the virtual hand model conformed to a user by a real-time virtual hand model control unit 3200.

The hand force measurement interface device 3500 includes various sensors for tracking a force load phenomenon induced in the hand using the virtual product. For example, the various sensors include pressure sensors and electromyogram (EMG) sensors. The sensor values obtained in real-time go through an adjustment such as a calibration filter and a sensibility adjustment and digital signal conversion by a hand force measurement interface control unit 3300.

The virtual hand model control data obtained by the real-time hand tracking interface 3100 and the real-time virtual hand model control unit 3200; and the force load measurement on the hand obtained by the hand force measurement interface control unit 3100 and the hand force measurement interface device 3500 are then output in a form of the virtual hand model visualized with the force load measurement by the force measurement result visualization unit 3400. That is to say, a user can objectively measure a feeling of the hand currently handling the virtual product by using the sensor values. Further, the virtual product model action visualization unit 3600 visualizes a current action status of the virtual product in a same manner with the visualization result output unit 2600 of FIG. 3 in order to increase understanding of the interrelationship between the virtual product and the hands.

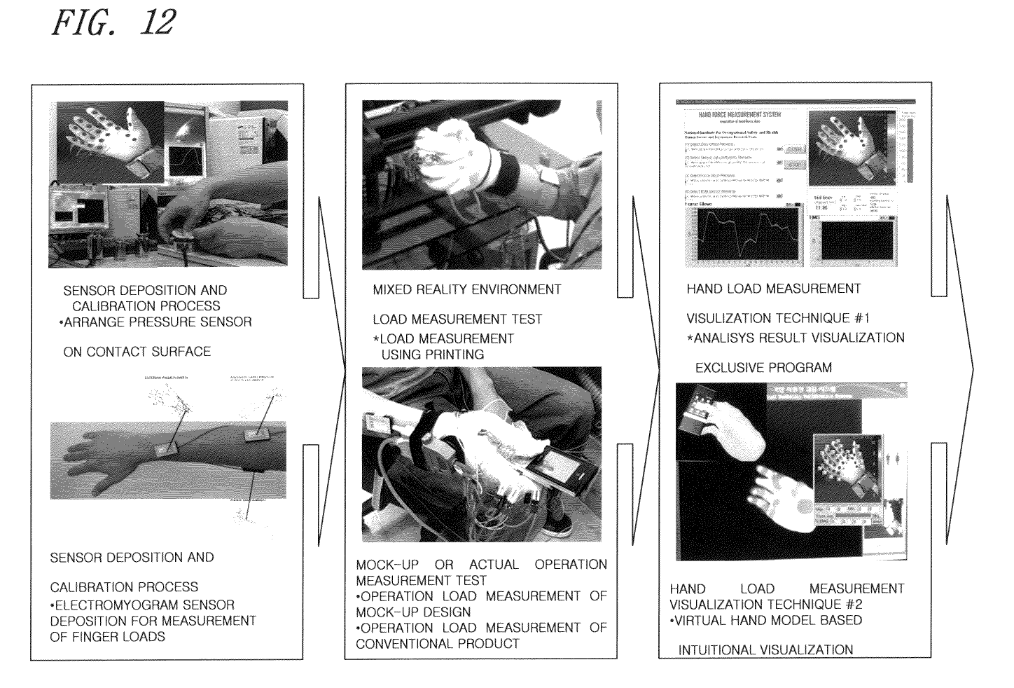

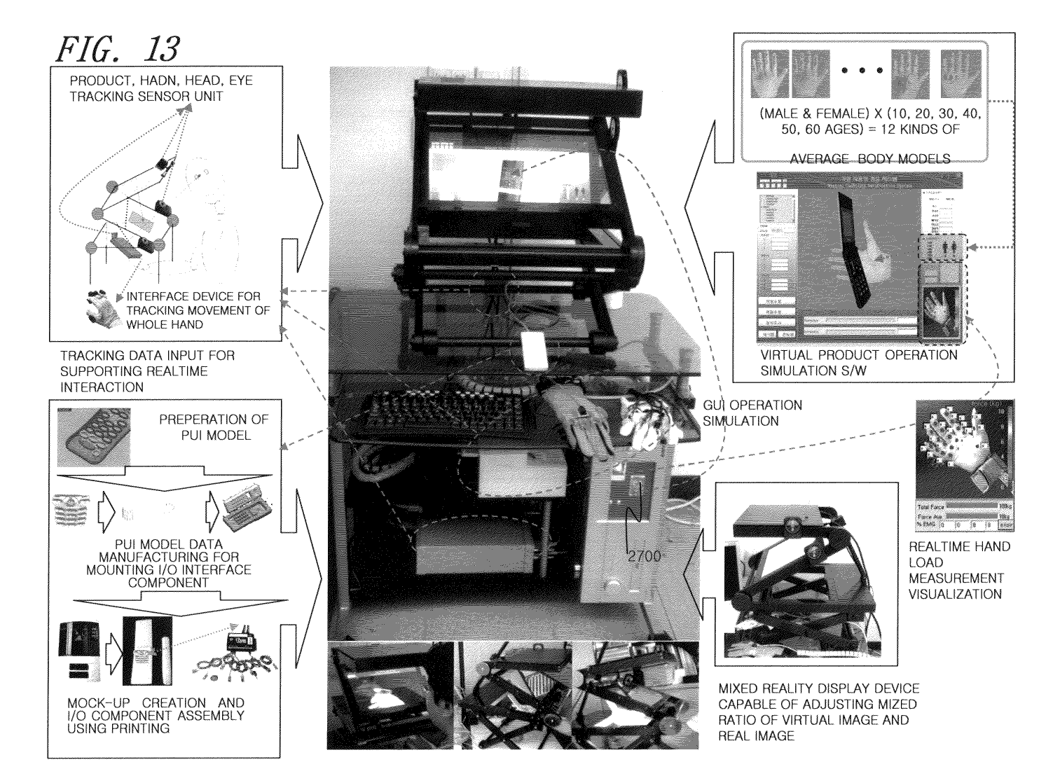

A force test result recording unit 3700 records a test currently in progress through video and audio recording devices and stores the control data for controlling the virtual hand model, an action status of the virtual hand model and an action situation of the virtual product which will then be used in analyzing after testing. FIGS. 12 and 13 depict an exemplary embodiment of the ergonomic based hand load evaluation group 3000 in accordance with the present invention. Such ergonomic based hand load evaluation group 3000 monitors in real-time a force relationship induced on the hand and visualizes the force relationship real-time by utilizing a 3D object and the virtual hand model. Therefore, it may be applied in various kinds of works (e.g., it can help in the process of mimicking how to give strength on a hand when a learner plays golf by measuring and visualizing an assistant tool performing evaluating and training of grasping a golf club and an expert's grasping of a golf club).

Moreover, a technology performed in the ergonomic based hand load evaluation group 3000 may support a quantitative usability evaluation test with respect to an interface operation of a current product or a product to be launched. For example, it is possible to compare a user's performance under circumstances of a UMPC keyboard layout or to measure a hand fatigue under circumstances of a UMPC keyboard layout. That is to say, the ergonomic based hand load evaluation module 3000 may be applied in a comparison process between a UMPC model with a keyboard laid out on both sides and a UMPC model with a keyboard slid in the bottom of a screen.

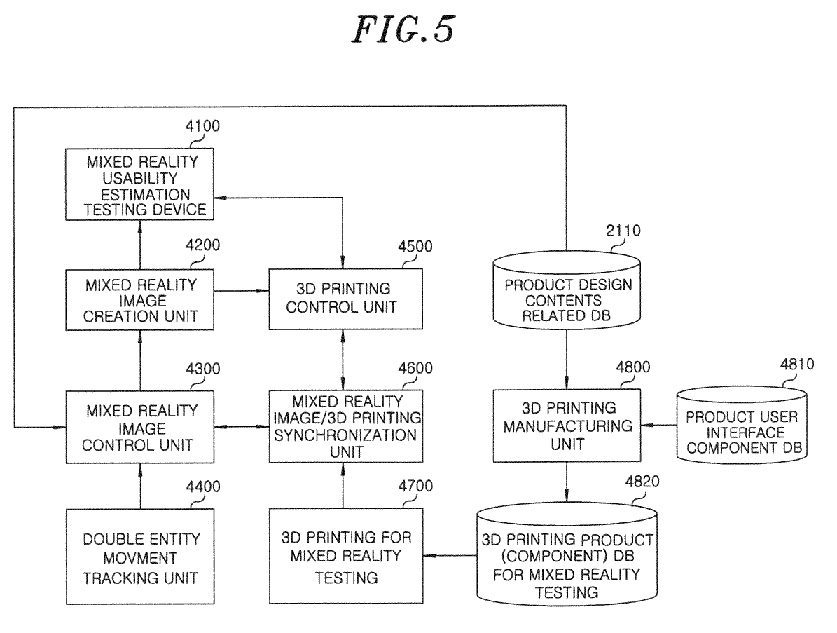

Referring back to FIG. 1, the mixed reality based usability evaluation platform group 4000 uses an augmented reality technology and a printing technology on the realized photo-realistic visualization and the virtual operation and transmits a usability evaluation situation based on the measured ergonomic based hand load and fatigue. The mixed reality based usability evaluation platform group 4000, as depicted in FIG. 5, includes an entity movement tracking unit 4400, a mixed reality image control unit 4300 and a mixed reality image creation unit 4200.

The entity movement tracking unit 4400 tracks in real-time the virtual product and movement of a user's hand and head and then transmits the same to the mixed reality image control unit 4300.

The mixed reality image control unit 4300 controls a parameter (e.g., rendering parameter of a virtual camera) in order to create a mixed reality image based on a mixed reality image display configuration and a tracked movement information. The mixed reality image creates the mixed reality image and the mixed reality image is projected and overlapped on a real object using a overly (an image overlapping) method (e.g., optical see-through method) through the mixed reality usability evaluation test device 4100.

A major function performed in the mixed reality based usability evaluation platform group 4000, i.e., a linking function between the physical user interface (PUI) and the graphic user interface (GUI) is realized by the product design contents related DB 2100 and blocks 4500 to 4820 depicted in FIG. 5. That is to say, in case a mixed reality test scenario with a function directly operated (e.g., button input) by a user is performed, a 3D printing manufacturing unit 4800 corrects the mixed reality test scenario on the basis of product's appearance (PUI) model data obtain from the product design (component) united DB 2110 and the product user interface component DB 4810 storing digital model data of physical interface (PUI) through CAD operation as 3D printing data, and 3D printing data is then stored in the 3D printing product (component) DB for mixed reality testing 4820. For example, the mixed reality test scenario uses a subtract operation among a 3D CAD data geometry modification method to delete a corresponding area to a keypad component on an upper plate of the cellular phone, thereby positioning a real keypad component that electrically/electronically operates in the 3D printing 4700.

As described above, the produced 3D printing data physically is employed to assembly a product in the 3D printing for the mixed reality 4700 with an electronic component (e.g., a keypad) using the 3D printing device (e.g., Z-printer of Z Corp.).

The 3D printing control unit 4500 interfaces an electronic/electric signal of PUI actually operating. An input value applied to the system goes through a mixed reality image/3D printing synchronization unit 4600 and is transmitted to the mixed reality image control unit 4300 for updating an action result of the virtual product. For example, in accordance with a direction button pressed by a user, the status of the GUI program performing in a parallel manner in the user interface control unit 2700 of FIG. 3 is updated, and result output by the visualization result output unit 2600 is visualized as the mixed reality image of a mixed reality environment by the mixed reality image control unit 4300 and the mixed reality image creation unit 4200.

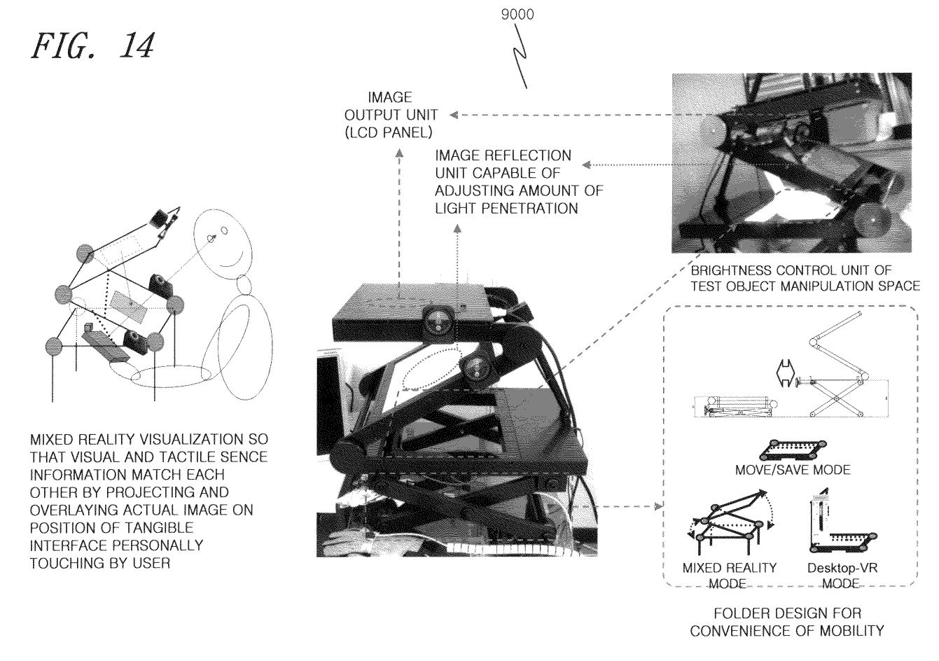

FIG. 14 depicts an exemplary embodiment of a display device of the mixed reality usability evaluation platform group 4000 in accordance with the present invention. When the appearance of the information appliance is determined and a specific design, layout and the like of a user interface component, etc. (e.g., a button and a keypad) are determined, a technology performed in the mixed reality usability evaluation group 4000 can be applied in demonstrating visually an action situation of an end product and simultaneously utilized in the course of decision making by performing a usability comparison test of the product while directly haptic touching a variety of interface products (PUI) to be completed in the future.

Referring to FIG. 14, the mixed reality based usability evaluation platform group 4000 projects a real image on a position of an object (e.g., a tangible interface) touched directly by a user, as depicted on the left of the FIG. 14, and supports the visualization of the mixed reality environment in accordance with visual and haptic sensual information. The embodiment depicted in FIG. 14 is designed as a folded structure for the convenience of the mobility and may support the usability evaluation scenario based on the mixed reality environment by adjusting an angle of a joint to conform to a general desktop based virtual reality mode centered on an image evaluation or a user's actual condition and a test condition.

In embodiment of FIG. 14, an image output unit includes a flat display panel for the reduction of volume and weight thereof and may includes a general LCD display, or a 3D display panel capable of supporting 3D glasses/no glasses/multi-foci, if necessary. The display panel has to directly present an image to a user's sight or an image via a mirror in order to support a folder type design modification scenario. Thus, the display panel needs to present an image in a flipped form at need.

In order to support the above functions, a software method (e.g., parameter adjustment of a graphic card driver) or a hardware method (e.g., a display panel and a display component panel are turned over and mounted to correspond to a turn over effect of the mirror) may be employed. Further, the display panel has a device using a non-reflective coating and a polarized filter for preventing a multi-image focus phenomenon due to the repetitive reflection (e.g., in case two mirrors face each other under an angle of 180 degrees, a phenomenon where a reflective image of an opposite mirror is reflected repetitively) which may be induced by facing a reflection unit of the display panel. “A image reflection unit capable of adjusting light penetration” depicted in FIG. 14 is engaged with “a test object operation space brightness control unit” and enables projecting the product image having an appropriate brightness on an object handled by a user in an evaluation scenario of the mixed reality environment. For example, the embodiment depicted in FIG. 14 use a translucent mirror which is a component of the reflecting unit coated at various ratios at need and designed as a detachable/attachable structure. Further, the embodiment depicted in FIG. 14, if necessary, additionally has an illumination device (e.g., a brightness control unit for the operation space of a object to be test) capable of adjusting in multi-levels a brightness of an small darkroom or an inner space of the display so that a mixed ratio of a virtual image of the object projected on the display panel and an actual image of the object held by a user can be controlled.

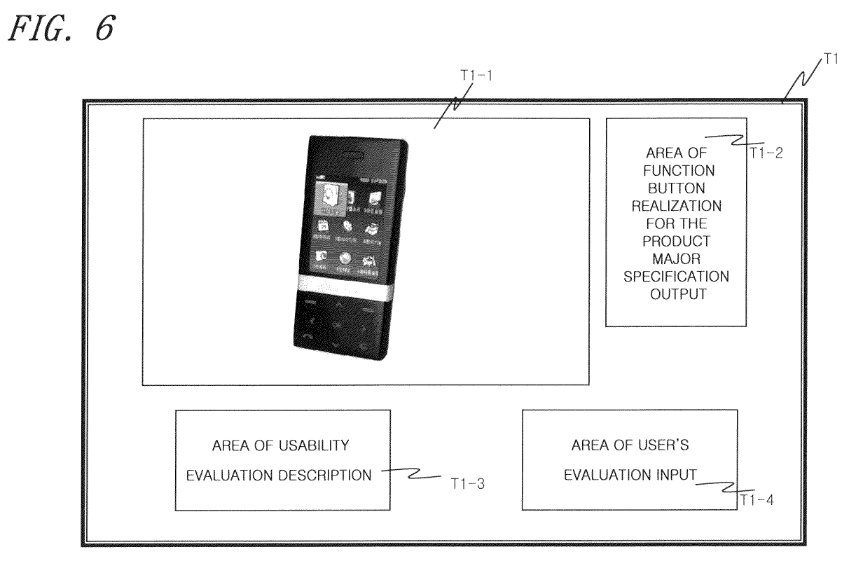

On the other hand, FIG. 6 is a detailed diagram of the online product design evaluation tool T1 in accordance with the present invention. The online product design evaluation tool T1 is an online tool capable of simple operation and evaluation of the virtual product extracted from the product DB and capable of simple recording of a user's evaluation result. In an area T1-1, a photo-realistic product image based on a high quality shader language (e.g., Nvidia's Cg) is visualized; in an area of a function button realization for the product major specification output T1-2, a product specification displayed in the area T1-1 and a simulation item of a major action of the product is exposed; in an area of usability evaluation description T1-3, a notice for collecting online based usability evaluation data is presented; and in an area of an user's evaluation input T1-4, a response to a question inquired in the usability evaluation description area T1-3 is entered.

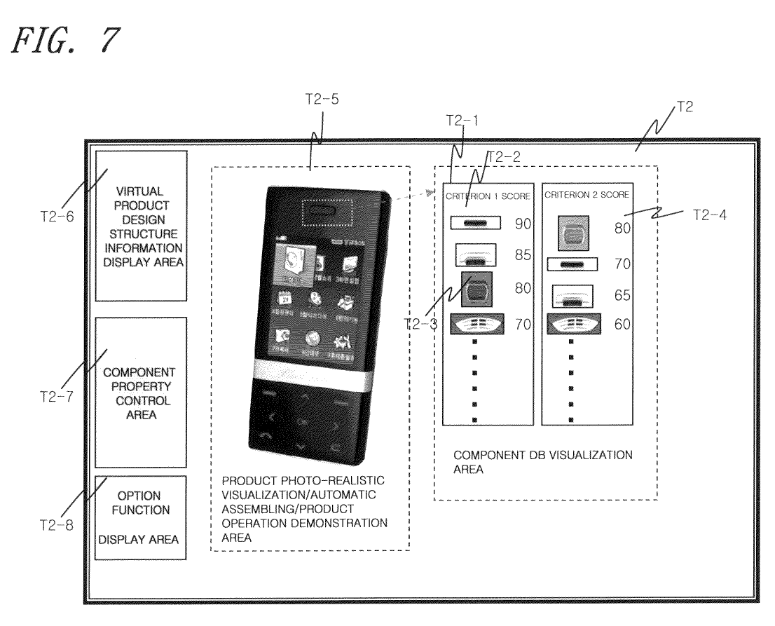

FIG. 7 is a detailed diagram of the online product design creation/modification tool T2 in accordance with the present invention. The online product design creation/modification tool T2 simulates an appearance and action of the virtual product based on data stored in the product design (component) united DB 2110 of FIG. 2. The user selects the product to be modified in a design thereof by directly selecting a displayed component in an area of a virtual product design structure information display area T2-6 or a product photo-realistic visualization/automatic assembling/product operation demonstration area T2-5. On an area of a component DB visualization T2-1 having areas of a criterion 1 score T2-2 and T2-3, and an area of a criterion 2 score T2-4 is presented a modification candidate list.

An exposure priority of the components is automatically adjusted by constant criterion information (e.g., an order of an emotional satisfaction result of the currently selected component, an order of statistical frequency in use of the currently selected component, etc.). Criterion capable of being presented is a recording of using the online design product evaluation tool T1 of FIG. 6 or statistical information stored in a recording of an offline design evaluation test unit 1300 of FIG. 2. For example, age, gender, time/era information, job, income, etc. may be used. In an area of a component property control T2-7, GUI capable of modifying tone and material information of the currently selected component is visualized. Moreover, in an area of an option function display T2-8, I/O information determining detailed values of other design parameter of the product is visualized.

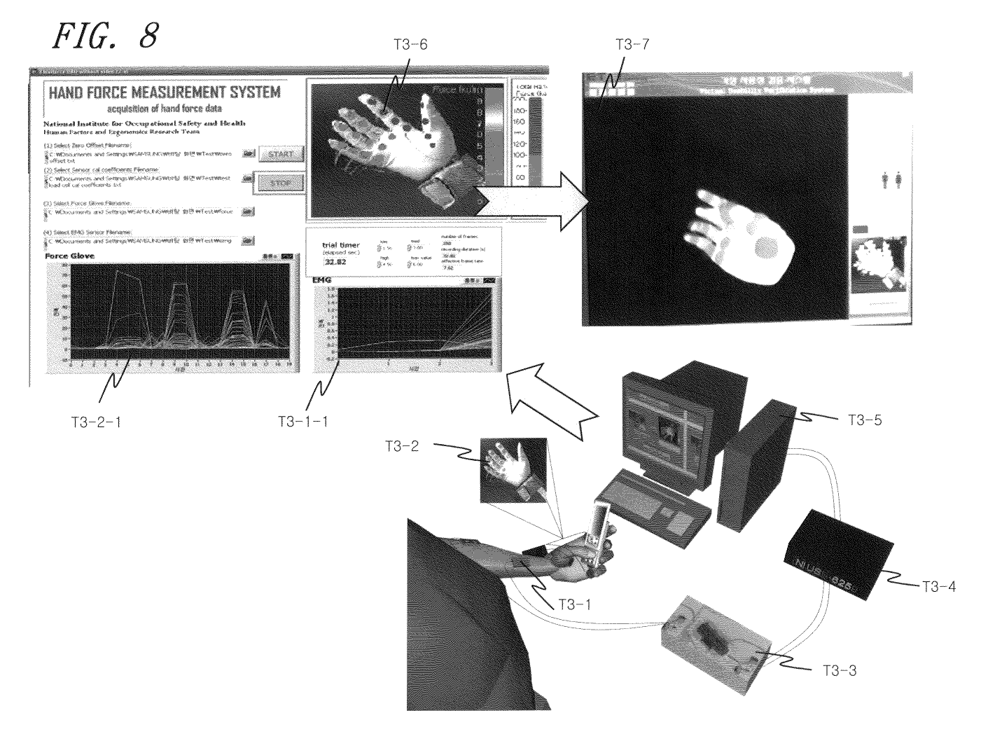

FIG. 8 is a detailed diagram of the hand interface based usability evaluation tool T3 depicting an exemplary embodiment of the ergonomic based hand load evaluation group 3000 of FIG. 1. The hand interface based usability evaluation tool T3 employs various sensors capable of quantitative measurement to measure several force phenomena induced on a user's body and supports so that the force phenomena are utilized in a usability analysis evaluation work by an ergonomic expert, etc.

For example, the embodiment of the hand interface based usability evaluation tool T3 shown in FIG. 8 describes an example mainly employing a sensor measuring a vertical pressure of characteristic points on a palm and an EMG sensor measuring a tension of a muscle controlling a finger. However, an embodiment of the hand interface based usability evaluation tool T3 is not limited to such specific sensors and may utilize sensor values obtained from various sensors in accordance with an analysis methodology. For example, instead of 1-axis pressure sensor, a sensor with a similar series but a different specification such as a 3-axis pressure sensor may be utilized, or a micro sensor utilizing MEMS technology in order to improve wearability and accuracy or a heterogeneous sensor such as a pulse sensor may be utilized.

To be specific, a sensor T3-1 measures a tension of a muscle in charge of a finger's movement and a force on a finger's joint correspondent to a hand's movement through the use of sensors, e.g., EMG sensors attached on a specific position in accordance with a criterion in a ergonomic test guidance. An area T3-2 is implemented with a form of a pressure glove as demonstrated in the present embodiment. Attached on the palm of the pressure glove are a thin film type of pressure sensors interfering minimally the interaction between a hand and a contact surface of the product.

Signals measured by both the EMG sensors and the pressure sensors are entered into in the program through a sensibility adjustment area T3-3 having a calibration filter and a digital-analogue convertor T3-4. Areas T3-1-1 and T3-2-1 are graphic user interfaces monitoring the sensor values in a real-time from the EMG sensors and the pressure sensors, and an area T3-6 is a graphic user interface for allowing a user to observe intuitively a distribution of the pressure values by matching numerical values to a tone spectrum. Further, an area T3-7 is a graphic user interface for more intuitively displaying a posture and pressure of the user's hand and the muscle fatigue information using a 3D hand model.

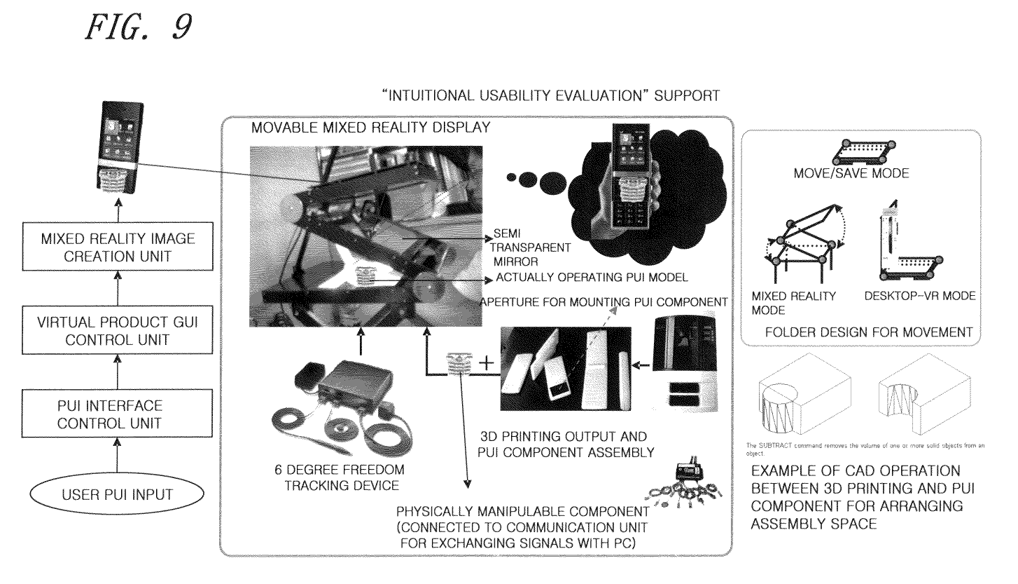

FIG. 9 is a detailed diagram of the virtual prototyping based usability evaluation tool T4 in accordance with the present invention, which is an exemplary embodiment of the mixed reality based usability evaluation group 4000 depicted in FIG. 1.

The embodiment of FIG. 9 obtains 3D data for the appearance of the virtual object, e.g., a cellular phone and 3D data for a keypad component thereof from DB in order to perform the evaluation on the appearance design of the cellular phone and the usability evaluation test by direct operation of the keypad. In the embodiment of FIG. 9, a 3D printing model with a hole at a portion of the keypad is created through a 3D volume subtraction operation (e.g., CAD operation), and an external model of the cellular phone is output by using a 3D printing output device. The keypad component capable of transmitting a signal electronically/electrically is mounted to the external model, and such event as button press information is input in a computer through an I/O board to link with a keyboard emulation program in which operation information of a user provided through the I/O board is analyzed as a key pad button operation information.

The emulation program transmits the signal from the keypad to a program parallel executed therewith, e.g., Adobe Flash that simulates GUI, e.g., GUI for a menu control on a screen, thereby simulating a modified shape of the cellular phone on the screen when a user presses a button of a real product. This simulation result is completed as an image of the cellular phone via the mixed reality image creation unit 4200 having a photo-realistic rendering function and the image is overlapped on a 3D printing (a cellular phone mockup) held by a user by way of an optical image projection structure of the mobile mixed reality display device. In case a user operates the cellular phone, a 3D spatial movement on a 3D space is tracked by a six degree of freedom tracking device and is real-time updated as the mixed reality image. In case a user presses a button on the keypad, a portion of GUI is updated accordingly.

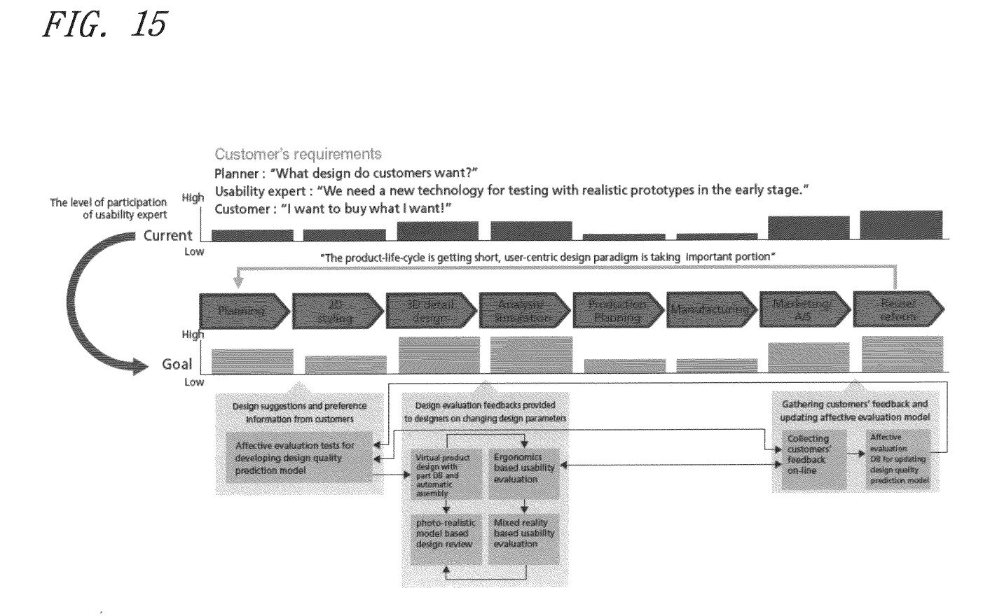

On the other hand, FIG. 15 is a diagram for schematically describing the present invention. The technical purpose of the present invention is to develop a united platform capable of early performing in a virtual environment a usability evaluation test only feasible when a design is completed and a mockup is made. That is to say, “The level of participation of usability expert” shows the level of an actual participation of usability evaluation expert who finds and improves usability problems of a product during the life cycle of the product. However, a usability technology such as “customer's requirements” suggested by the present invention tries to solve problems of a planner, a customer and a usability expert.

According to the present invention, design preference information of current market (customer) and a prototype of a candidate product that assist to determine a new design may be visualized to a user under a product planning and a 2D styling design as shown in FIG. 15. Moreover, the present invention allows a developer under plotting a 3D detail design, function analysis and simulation to perform in a mixed reality environment preference change estimation in view of a customer regarding the modification of product design parameters, design evaluation based on a photo-realistic model and ergonomic analysis. Further, in a step of marketing and design correction, the present invention collects in real-time information on a usability evaluation for the current design obtained from multiple users in online environment and information on design improvement guideline to enable fast feedback on lifetime cycle of an object.

Therefore, the present invention unites various digital data created during a product planning and designing to operate the digital data as one virtual product, and unites a virtual reality technology which visualizes the virtual product to a photo-realistic level, an affective technology which organizes a customer's emotional evaluation for a product's design in view of engineering, an ergonomic technology which quantatively measures and analyzes dynamical body activity involved in the operation of the product in view of biomechanic, and a mixed reality technology which supports both a tangible interface capable of directly touching the digital data and a photo-realistic visualization. Accordingly, it is possible to find problems of usability early, obtain improvements such as a design of the product, improve efficiently an overall quality of the product and manage product-lifetime-cycle in a company manufacturing the product.

While the present invention has been described with respect to certain preferred embodiments, it will be apparent to those skilled in the art that various changes and modifications may be made without departing from the scope of the invention as defined in the following claims.

What is claimed is:

1. A system for evaluating usability of a virtual mobile information appliance, comprising:
a design evaluation unit for supporting emotional evaluation of a designed product in accordance with a component DB and a partially standardized guide in view of a customer and for real-time collecting design preference data based on a network online system;
a virtual product design modification and action simulation unit for uniting digital data related with the designed product to realize a photo-realistic visualization and a virtual operation;
an ergonomic based hand load evaluation unit for measuring an ergonomic based hand load and a fatigue using a hand interface based usability evaluation tool; and
a mixed reality usability evaluation unit for applying an augmented reality technology and a printing technology to the realized photo-realistic visualization and the virtual operation and for creating a usability evaluation situation based on the measured ergonomic based hand load and fatigue to provide the created usability evaluation situation to a user.

2. The system of claim 1, wherein the design evaluation unit further performs deducting an interrelationship with parameters of the designed product using a product design stored in the product design united DB or newly modified additionally by an online product design creation/modification tool to estimate an emotional design satisfaction from the interrelationship.

3. The system of claim 2, wherein, when the online product design creation/modification tool is used, an exposure priority of the designed product is controlled in the product design united DB and the modified product design is evaluated and given feedback on the basis of parameters of the designed product.

4. The system of claim 1, wherein the design evaluation unit further performs updating an emotional evaluation estimation model based on a scenario of offline design evaluation and online design evaluation.

5. The system of claim 4, wherein the offline design evaluation executes a test performed offline on a web service connected by using an online product design evaluation tool.

6. The system of claim 5, wherein the virtual product design modification and action simulation unit further performs collecting and updating user information based on a web service in order to update data in a design emotional evaluation estimation engine by linking with the online product design evaluation tool.

7. The system of claim 1, wherein the virtual product design modification and action simulation unit further performs correcting and conforming automatically size, position and shape data and property data of the product in consideration with spatial interrelationship with the product, when the product is modified.

8. The system of claim 1, wherein the virtual product design modification and action simulation unit includes:
a virtual product structure editing unit for expressing a structure of components in a virtual product in a hierarchical structure using 3D computer graphics and virtual reality simulation to store structural movement information of each component and configuration information of a product defining an operation form of the product responding to an external input event into a product assembling information DB;
an automatic assembling support processing unit for continuously maintaining an interrelationship between components when the parameters are modified by the configuration information stored in the product assembling information DB;
a virtual product design adjustment unit for correcting the parameter automatically or manually so that parameters between the components are adjusted to be an assembled product when the design parameter is modified;
a virtual product action editing unit for inserting mechanism information to each component stored in the product design united DB;
a virtual product visualization property editing unit for correcting material and property information of the virtual product stored in the product design united DB;
a user interface control unit for interfacing multiple programs executed in parallel with the online product design creation/modification tool using a real-time screen capturing method;
a virtual product united model visualization unit for visualizing the interfaced programs, the material and property information of the corrected product, the component having the mechanism information inserted therein and the corrected design parameter as a virtual product action in a united form; and
a visualization result output unit for simulating the visualized action.

9. The system of claim 1, wherein the ergonomic based hand load evaluation unit includes:
a real-time hand tracking interface for tracking in real-time angles between finger's joints and posture information of a hand using sensors to obtain in real-time joint angle information so that a virtual hand model is restored and visualized in real-time;
a real-time virtual hand model control unit for converting and adjusting the obtained joint angel information into a virtual hand model control data for controlling the virtual hand model corresponding to the user;
a hand force measurement interface device for tracking and obtaining a force load phenomenon induced at the hand by using sensors;
a hand force measurement interface control unit adjusting and converting the obtained force load phenomena to a force load measurement on the hand;
a force measurement result visualization unit for visualizing the virtual hand model control data and the force load measurement on the virtual hand model;
a virtual product model action visualization unit for visualizing an action of the virtual product for increasing understanding of an interrelationship between the virtual product and the hand; and
a force test recording unit for recording the action of the virtual product to apply it in an analysis of the virtual product after a test.

10. The system of claim 9, wherein the force load obtained by the hand force measurement interface device is measured by pressure sensors and electromyogram (EMG) sensors.

11. The system of claim 1, wherein the mixed reality usability evaluation unit includes:
a double entity movement tracking unit for tracking in real-time a movement of a product to be evaluated;
a product user interface component DB for storing model data of the product to be evaluated;
a 3D printing manufacturing unit for correcting the product to be evaluated on the basis of the stored model data to produce as a 3D printing data, the 3D printing data being stored in a 3D printing product DB for mixed reality;
a 3D printing for mixed reality for assembling the 3D printing data by using a 3D printing device;
a 3D printing control unit for interfacing an operational value made physically through a user's input operation;
a mixed reality image control unit for controlling to create a mixed reality image using the interfaced operational value based on the tracked movement information;
a mixed reality image creation unit for creating the mixed reality image under the control of the mixed reality image control unit; and
a mixed reality usability evaluation test device for projecting and overlapping the created mixed reality image on a real object by using an overlay method.

12. The system of claim 1, wherein the usability evaluation situation created by the mixed reality based usability evaluation unit is realized using a virtual prototyping based usability evaluation tool.

13. A method for evaluating usability of a virtual mobile information appliance, comprising:
supporting an emotional evaluation in view of a customer on a product designed in accordance with a component DB and a partially standardized guide and real-time collecting design preference data based on a network online system;
realizing a photo-realistic visualization and a virtual operation by uniting digital data related with the designed product;
measuring an ergonomic based hand load and fatigue using a hand interface based usability evaluation tool; and
applying an augmented reality technology and a printing technology to the realized photo-realistic visualization and virtual operation, and creating a usability evaluation situation based on the measured ergonomic based hand load and fatigue to provide the created usability evaluation situation to a user.

14. The method of claim 13, wherein the step of realizing photo-realistic visualization and virtual operation includes:
expressing components of a virtual product in a hierarchical structure using 3D computer graphics and virtual reality simulation to store structural movement information of each component and configuration information of the product defining an operation form of the product responding to an external input event into a product assembling information DB;
continuously maintaining an interrelationship between the components when a design parameter is modified by the configuration information stored in a product assembling information DB;
automatically or manually correcting the design parameter so that physical design parameter between the components is adjusted to be an assembled product when the design parameter is modified;
inserting mechanism information to each component stored in the product design united DB;
correcting material and property information of a virtual product stored in the product design united DB;
interfacing multiple programs executed in parallel with an online product design creation/modification tool using a real-time screen capturing method;
visualizing the interfaced programs, the material and property information of the corrected product, the component having mechanism information inserted therein, and the corrected design parameter as a virtual product action of a united form; and
simulating the visualized action.

15. The method of claim 13, wherein the step of measuring ergonomic based hand load and fatigue includes:
Real-time tracking angles between finger' joints and posture information of a hand of a user using sensors to obtain in real-time joint angle information so that a virtual hand model is restored and visualized in real-time;
converting and adjusting the obtained joint angel information into virtual hand model control data for controlling the virtual hand model corresponding to the user;
tracking and obtaining force load phenomenon induced at the hand by using sensors;
adjusting and converting the obtained force load phenomena to a force load measurement on the hand;
visualizing the virtual hand model control data and the force load measurement on a virtual hand model;
visualizing an action of the virtual product in order to increase understanding of an interrelationship between the virtual product and the hand; and
recording the action of the designed product to apply it in an analysis of the designed product after a test.

16. The method of claim 13, wherein the step of applying an augmented reality technology and a printing technology includes:
real-time tracking a movement of the virtual product to be evaluated;
storing model data of the product to evaluated;
correcting a product to be evaluated on the basis of the stored model data to produce a 3D printing data;
assembling the 3D printing data by using a 3D printing device;
interfacing a value input physically;
creating a mixed reality image using the interfaced value based on the tracked movement information; and
projecting and overlapping the created mixed reality image on a real object using an overlay method.
